(19) United States
(12) Patent Application Publication
(10) Pub. No.: US 2012/0320457 A1
(43) Pub. Date: Dec. 20, 2012

(54) POLARIZATION MODULE AND IMAGE DISPLAY APPARATUS

(76) Inventor: Ryoko HORIKOSHI, Kanagawa (JP)

(21) Appl. No.: 13/494,090

(22) Filed: Jun. 12, 2012

(30) Foreign Application Priority Data
Jun. 17, 2011 (JP) 2011-134913
Jun. 20, 2011 (JP) 2011-136346

(51) Int. Cl. G02B 27/26; G02B 5/30

(52) U.S. Cl. 359/465; 359/483.01

(57) ABSTRACT

A polarization module including first quarter-wave plates disposed on a polarizer plate and having slow axes inclined to a polarization axis of the polarizer plate by 45 degrees. Second quarter-wave plates are disposed on the polarizer plate alternately with the first quarter-wave plates and have slow axes inclined to the polarization axis of the polarizer plate by 45 degrees but face away from the slow axes of the first quarter-wave plates. Half-wave plates are disposed on the first and second quarter-wave plates and are arranged in a direction that intersects the direction in which the first and second quarter-wave plates are arranged.

### FIELD

The present technology relates to a polarization module for displaying stereoscopic images and an image display apparatus using the polarization module.

### BACKGROUND

In recent years, image display apparatus that provide stereoscopic images are under development. An image display apparatus of this type displays images corresponding to parallax between the right and left eyes. A viewer, for example, wears eyeglasses including a lens for the right eye provided with a filter that selectively transmits light that forms an image for the right eye and a lens for the left eye provided with a filter that selectively transmits light that forms an image for the left eye to visually recognize stereoscopic images.

For example, to allow an image for the right eye and an image for the left eye to be selected by the respective filters described above, the two images are displayed with differently polarized light fluxes (see JP-A-4-263596, for example).

For example, JP-A-4-263596 discloses a technique for separating an image for the right eye and an image for the left eye from each other by using two light fluxes circularly polarized in opposite directions.

That is, light emitted from a planar panel display unit is first converted into linearly polarized light. The linearly polarized light then passes through a wave plate formed of a quarter-wave plate and a three-quarter-wave plate alternately arranged in a single predetermined direction. The linearly polarized light passing through the quarter-wave plates and the linearly polarized light passing through the three-quarter-wave plates are converted into two types of light fluxes circularly polarized in opposite directions before delivered to the viewer.

The viewer wears eyeglasses including a lens for the right eye provided with a polarization filter that only transmits circularly polarized light for the right eye and a lens for the left eye provided with a polarization filter that only transmits circularly polarized light for the left eye to visually recognize stereoscopic images.

The method described above is what is called a line-by-line method, in which a quarter-wave plate and a three-quarter-wave plate are alternately arranged on a polarizer plate, for example, on a row basis.

Instead of using the method for arranging wave plates as described above, there is an alternative method using a polarizer plate having two types of area having different polarizing characteristics, specifically, having polarization directions perpendicular to each other, formed in a checkerboard pattern (see JP-A-61-156021, for example).

In this method, an area where an image for the right eye and an area where an image for the left eye are arranged in a checkerboard pattern.

### SUMMARY

As described above, a variety of methods for displaying stereoscopic images have been proposed. In this technical field, however, high-quality images are still not readily displayed at reasonable costs.

In view of the facts described above, it is desirable to provide a polarization module and an image display apparatus capable of displaying stereoscopic images with higher image quality in a more simplified manner.

An embodiment of the present technology is directed to a polarization module including a polarizer plate and a plurality of first quarter-wave plates so disposed on the polarizer plate at predetermined intervals that slow axes of the first quarter-wave plates are inclined to a polarization axis of the polarizer plate by 45 degrees.

The polarization module according to the embodiment of the present technology further includes a plurality of second quarter-wave plates so disposed on the polarizer plate in alternation with the first quarter-wave plates that slow axes of the second quarter-wave plates are inclined to the polarization axis of the polarizer plate by 45 degrees but face away from the slow axes of the first quarter-wave plates.

The polarization module according to the embodiment of the present technology further includes a plurality of half-wave plates so disposed at predetermined intervals on the plurality of first quarter-wave plates and the plurality of second quarter-wave plates that the direction in which the plurality of half-wave plates are arranged intersects the direction in which the plurality of first quarter-wave plates and the plurality of second quarter-wave plates are arranged.

Another embodiment of the present technology is directed to an image display apparatus including a display panel having first pixel areas for displaying an image for the right eye and second pixel areas for displaying an image for the left eye and the polarization module described above disposed on the display panel.

According to the polarization module and the image display apparatus, the plurality of half-wave plates are so disposed on the plurality of first quarter-wave plates and the plurality of second quarter-wave plates that the direction in which the plurality of half-wave plates are arranged intersects the direction in which the plurality of first quarter-wave plates and the plurality of second quarter-wave plates are arranged. The areas for displaying an image for the right eye and the areas for displaying an image for the left eye are therefore alternately arranged in two directions that intersect each other.

In the polarization module and the image display apparatus according to the embodiments of the present technology, the areas for displaying an image for the right eye and the areas for displaying an image for the left eye can be readily alternately arranged in two directions that intersect each other. As a result, image resolution in the vertical and horizontal directions can be of the same level or balanced with each other, whereby the image quality can be improved.

### BRIEF DESCRIPTION OF THE DRAWINGS

FIGS. 1A to 1C are schematic configuration diagrams showing the configuration of a polarization module according to a first embodiment of the present technology;

FIG. 2 shows areas where images for the right and left eyes are displayed in the polarization module according to the first embodiment of the present technology;

FIG. 3 shows how the polarization module according to the first embodiment of the present technology is attached to a display panel;

FIGS. 4A to 4C show the configuration of a polarization module according to Comparative Example;

FIGS. 5A to 5C show the configuration of a polarization module according to a second embodiment; and

FIG. 6 shows an image display apparatus according to a third embodiment.

### DETAILED DESCRIPTION

Exemplary modes for carrying out the present technology will be described below, but the present technology is not limited to the following embodiments.

The description will be made in the following order.

1. First embodiment (a case where quarter-wave plates are bonded to a resin plate)

2. Second embodiment (a case where half-wave plates are bonded to a resin plate)

3. Third embodiment (example of image display apparatus)

### 1. First Embodiment

### A Case Where Quarter-Wave Plates are Bonded to a Resin Plate

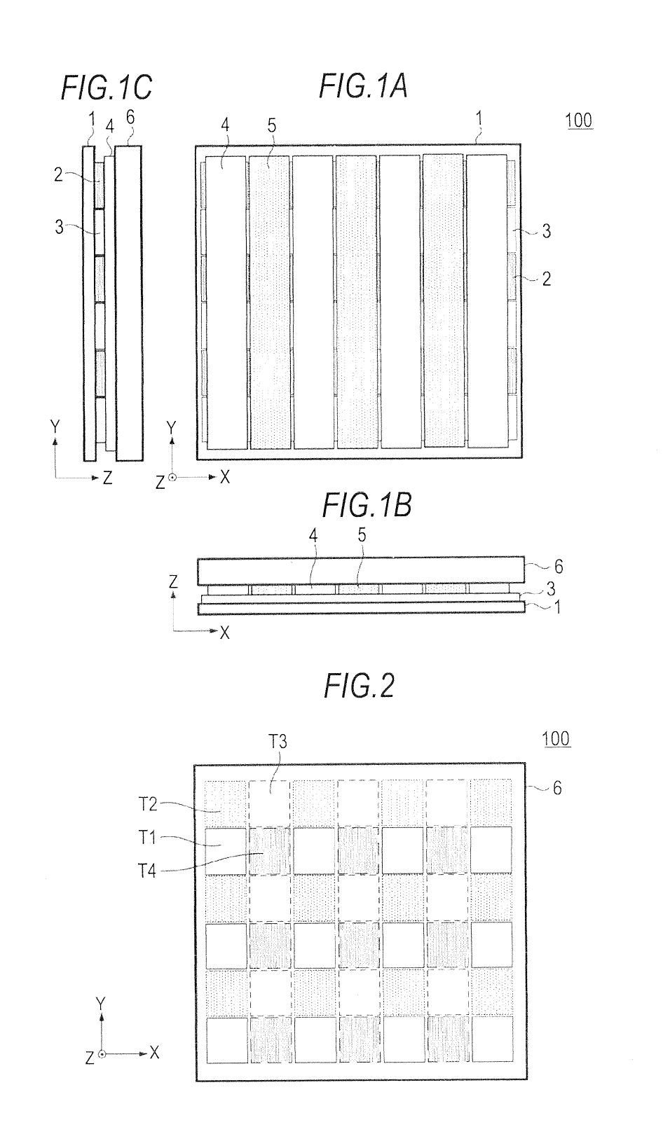

FIGS. 1A to 1C are schematic configuration diagrams showing the configuration of a polarization module 100 according to a first embodiment. FIG. 1A shows the polarization module 100 viewed in the direction perpendicular to one principal surface thereof (Z-axis direction). FIG. 1B shows the polarization module 100 viewed in a Y-axis direction. FIG. 1C shows the polarization module 100 viewed in an X-axis direction.

The polarization module 100 according to the present embodiment includes a polarizer plate 1 and a plurality of first wave plates 2 and a plurality of second wave plates 3 disposed on one principal surface of the polarizer plate 1.

The polarization module 100 according to the present embodiment further includes a plurality of third wave plates 4 and a plurality of transparent double-sided adhesive tapes 5 disposed on the plurality of first wave plates 2 and the plurality of second wave plates 3.

A resin plate 6 is disposed on the plurality of third wave plates 4 but is not shown in FIG. 1A for ease of illustration.

The polarizer plate 1 can be any polarizer plate that only transmits light polarized in a predetermined direction. For example, a representative example of a polarizer plate used in an image display apparatus is formed of a film obtained by uniaxially stretching a resin containing iodine, a dichromatic pigment, or any other suitable dichromatic substance and primarily made of polyvinyl alcohol (PVA) and a protective film bonded to both surfaces of the film. The polarizer plate 1 in the present embodiment may have the same configuration described above.

The plurality of first wave plates 2 and the plurality of second wave plates 3 are disposed on one principal surface of the polarizer plate 1. Each of the first wave plates 2 and the second wave plates 3 is fixed to the polarizer plate 1, for example, with an optical adhesive, a UV curable resin, a photoelastic resin, or an optical adhesive tape.

The first wave plates 2 and the second wave plates 3 can be the same quarter-wave plates.

It is, however, noted that the first wave plates 2 are so disposed that the slow axes thereof are inclined to the polarization axis of the polarizer plate 1, for example, by +45° and the second wave plates 3 are so disposed that the slow axes thereof are inclined to the polarization axis of the polarizer plate 1, for example, by −45°. That is, the slow axes of the second wave plates 3 are inclined to the polarization axis of the polarizer plate 1 by 45° but face away from the slow axes of the first wave plates 2.

The first wave plates 2 turned upside-down and disposed on the first polarizer plate 1 therefore form the second wave plates 3.

The first wave plates 2 and the second wave plates 3, each of which has, for example, a rectangular principal surface, are alternately arranged along the shorter side of the rectangular principal surface (Y-axis direction in FIG. 1A), as shown in FIG. 1A.

When there is a gap between an adjacent pair of first wave plate 2 and second wave plate 3, air layers are present between the polarizer plate 1 and the third wave plates 4 (or double-sided adhesive tapes 5). In this case, light tends to be reflected off the interface between the polarizer plate 1 and the air layers, and the reflected light can disadvantageously form another image (contaminate original image).

It is therefore preferable that the gap between an adjacent pair of first wave plate 2 and second wave plate 3 is as small as practically possible.

The plurality of third wave plates 4 and the plurality of transparent double-sided adhesive tapes 5 are disposed on the first wave plates 2 and the second wave plates 3. Each of the third wave plates 4 is a half-wave plate, and the slow axis thereof is oriented in the same direction as the slow axes of the first wave plates 2 or the second wave plates 3.

Further, each of the third wave plates 4 has, for example, a rectangular principal surface, and the third wave plates 4 and the transparent double-sided adhesive tapes 5 are alternately arranged along the shorter sides of the third wave plates 4. The direction in which the third wave plates 4 and the double-sided adhesive tapes 5 are arranged intersects (at right angles) the direction in which the first wave plates 2 and the second wave plates 3 are arranged.

The transparent resin plate 6 having optical transparency is disposed over the plurality of first wave plates 2 and second wave plates 3. The resin plate 6 preferably is optically isotropic. The resin plate 6 can thus protect the first wave plates 2 and the second wave plates 3 without affecting polarized light having passed therethrough.

The resin plate 6 having optical isotropy is made, for example, of polymethyl methacrylate (PMMA). The thus formed resin plate 6, which is lighter and less prone to breakage than, for example, a glass plate, is particularly effective in attaching the polarization module 100 to a large-screen display panel.

The resin plate 6 is fixed to the first wave plates 2 and the second wave plates 3 with the double-sided. adhesive tapes 5. To allow the resin plate 6 to come into intimate contact with the double-sided adhesive tapes 5 in a reliable manner, the double-sided adhesive tapes 5 are preferably thicker than the third wave plates 4.

The surface of the polarization module 100 can be planarized by disposing the resin plate 6 on the plurality of third wave plates 4.

An antireflection film, a UV blocking film, a hard coating, or any other functional film may be formed on the resin plate 6.

The resin plate 6 may further be anti-glared by forming fine irregularities thereon in advance when the resin plate 6 is formed in a molding process.

Attaching the resin plate 6 to the surface of the polarization module 100 allows a variety of types of surface processing, such as those described above, to be readily performed. In particular, the resin plate 6, when it has UV blocking capability, can preferably protect the first wave plates 2 and the second wave plates 3 (quarter-wave plates), which have relatively low resistance to ultraviolet light. The resin plate 6 can alternatively contain a UV blocking agent.

Since the double-sided adhesive tapes 5 are in intimate contact with the resin plate 6, no air layer is present between the double-sided adhesive tapes 5 and the resin plate 6, but a thin air layer can be present between the third wave plates 4 and the resin plate 6. When an air layer is present between the third wave plates 4 and the resin plate 6, light tends to be reflected off the interface between the air layer and the third wave plates 4 or the interface between the air layer and the resin plate 6. It is therefore preferable to form an antireflection film on the principal surface of each of the third wave plates 4 that faces the resin plate 6. An anti reflection film can also be formed on the principal surface of the resin plate 6 that faces the wave plates 4.

FIG. 2 is a diagrammatic view showing areas T1 to T4 located across the resin plate 6 of the polarization module 100 according to the present embodiment. The areas T1 and T3 transmit, for example, light that forms an image for the right eye, and the areas T2 and T4 transmit, for example, light that forms an image for the left eye.

For example, when viewed in the direction perpendicular to the principal surface of the resin plate 6 (Z-axis direction), the areas T1 are areas where the second wave plates 3 overlap with the third wave plates 4, and the areas 13 are areas where the first wave plates 2 overlap with the double-sided adhesive tapes 5.

Similarly, the areas T2 are areas where the first wave plates 2 overlap with the third wave plates 4, and the areas T4 are areas where the second wave plates 3 overlap with the double-sided adhesive tapes 5.

That is, across the resin plate 6, an area through which light that forms an image for the right eye exits and an area through which light that form an image for the left eye exits are alternately positioned along two axial directions perpendicular to each other (X-axis and Y-axis directions in FIG. 2).

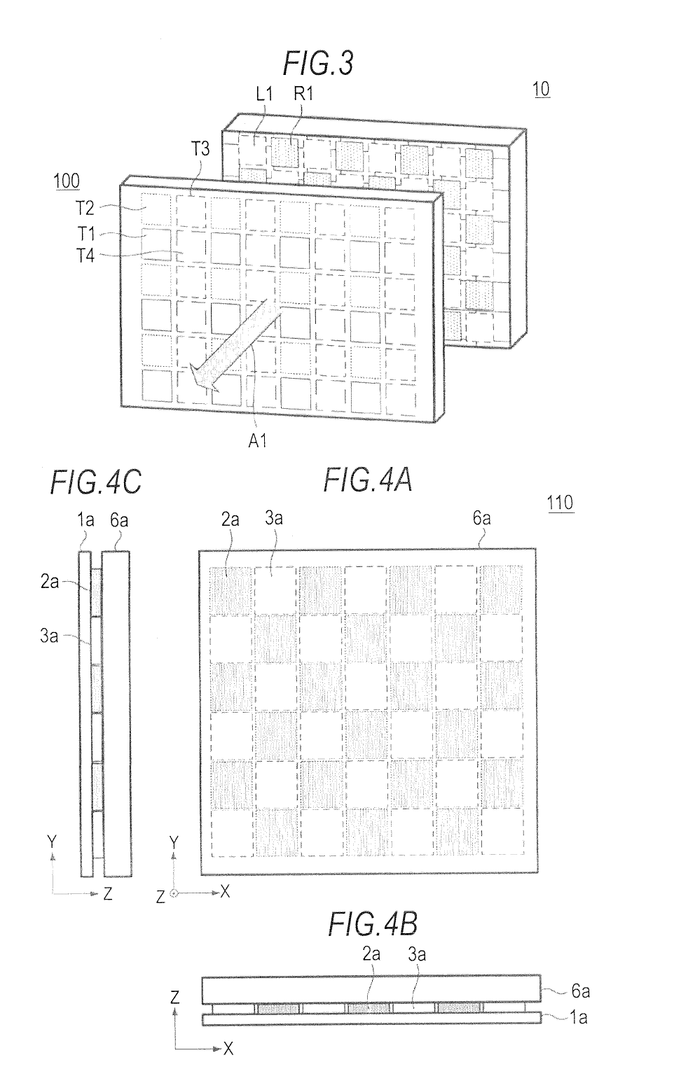

The polarization module 100 is overlaid on and attached to an image-displaying surface of a display panel 10, as shown in FIG. 3. In this process, the polarization module 100 is so positioned that the polarizer plate 1 thereof is overlaid on the display panel 10. Light emitted from the display panel 10 passes through the polarization module 100 and reaches the eyes of a viewer, as indicated by the arrow A1.

The image-displaying surface of the display panel 10 has, for example, three primary color pixels, R (red), G (green), and B (blue) pixels, arranged in a matrix. The pixels may, for example, be liquid crystal display pixels. Alternatively, when forming a large-area display screen, the pixels may be LEDs (light emitting diodes), organic EL (organic electro-luminescence) devices, or any other suitable self-luminous devices.

Among the pixels, those within an area R1 of the display panel 10 display an image for the right eye, and those within an area L1 of the display panel 10 display an image for the left eye. The areas R1 and L1 are alternately arranged within the image-display surface of the display panel 10 along two directions that intersect each other (at right angles).

When the polarization module 100 is overlaid on the display panel 10, the areas T1 and T3 of the polarization module 100 are located on the pixels in the areas R1 and the areas T2 and T4 of the polarization module 100 are located on the pixels in the areas L1.

In FIGS. 1A to 1C, 2, and 3, in which the polarization module 100 and the display panel 10 are diagrammatically drawn, the size, the number, and other features of the first wave plates 2, the second wave plates 3, the pixels, and a variety of other components are changed as appropriate. Further, the number of pixels within each of the areas R1 and L1 of the display panel 10 may also be changed as appropriate.

For example, part of the light emitted from the pixels within the areas R1 of the display panel 10 is incident on the areas T1 of the polarization module 100, and the incident light passes through the polarizer plate 1, which converts the light into linearly polarized light. The linearly polarized light having passed through the areas T1 then passes through the second wave plates 3, which convert the light into circularly polarized light (clockwise, for example, for the sake of description). The light having passed through the second wave plates 3 then passes through the third wave plates 4, which convert the light into circularly polarized light in the opposite direction (counterclockwise), and exits out of the polarization module 100.

Further, part of the light emitted from the pixels within the areas R1 of the display panel 10 is incident on the areas T3 of the polarization module 100, and the incident light passes through the polarizer plate 1, which converts the light into linearly polarized light. The linearly polarized light then passes through the first wave plates 2, which convert the light into circularly polarized light (counterclockwise). The circularly polarized light then passes through the double-sided adhesive tapes 5 and the resin plate 6 and exits out of the polarization module 100.

That is, the light fluxes having passed through the areas T1 and T3 of the polarization module 100 are converted into light fluxes circularly polarized in the same direction.

On the other hand, part of the light emitted from the pixels within the areas L1 of the display panel 10 is incident on the areas T2 of the polarization module 100, and the incident light passes through the polarizer plate 1, which converts the light into linearly polarized light. The linearly polarized light then passes through the first wave plates 2, which convert the light into circularly polarized light (counterclockwise). The circularly polarized light then passes through the third wave plates 4, which convert the light into circularly polarized light in the opposite direction (clockwise), and exits out of the polarization module 100.

Further, part of the light emitted from the pixels within the areas L1 of the display panel 10 is incident on the areas T4 of the polarization module 100, and the incident light passes through the polarizer plate 1, which converts the light into linearly polarized light. The linearly polarized light then passes through the second wave plates 3, which convert the light into circularly polarized light (clockwise). The circularly polarized light then passes through the double-sided adhesive tapes 5 and the resin plate 6 and exits out of the polarization module 100.

That is, the light fluxes having passed through the areas T2 and T4 of the polarization module 100 are converted into light fluxes circularly polarized in the direction opposite to the direction in which the light having passed through the areas T1 and T2 are circularly polarized.

The viewer wears eyeglasses including a lens for the left eye with a circular polarization filter that transmits the circularly polarized light through the areas corresponding to the pixels within the areas L1 (areas T2 and T4) and a lens for the right eye with a circular polarization filter that transmits the circularly polarized light through the areas corresponding to the pixels within the areas R1 (areas T1 and T3). The viewer can thus visually recognize stereoscopic images.

As described above, the polarization module 100 according to the present embodiment can convert the light emitted from the areas R1, which are located on the display panel 10 and display an image for the right eye, and the light emitted from the areas L1, which are located on the display panel 10 and display an image for the left eye, into light fluxes circularly polarized in opposite directions.

In particular, in the polarization module 100 according to the present embodiment, the areas through which circularly polarized light, for example, for the right eye exits (areas T1 and T3) and the areas through which circularly polarized light, for example, for the left eye exits (areas T2 and T4) are alternately arranged in two directions perpendicular to each other. As a result, the vertical resolution and the horizontal resolution can be of substantially the same level, whereby the image resolution in the vertical direction (Y-axis direction) can be increased as compared with that in related art. Further, the vertical resolution can therefore be balanced with the horizontal resolution.

For example, consider a case where areas for displaying an image for the right eye correspond to odd-numbered pixel rows and areas for displaying an image for the left eye correspond to even-numbered pixel rows in a line-by-line method of related art. In this case, the areas for displaying an image for the right eye and the areas for displaying an image for the left eye are alternately arranged in the vertical direction (column direction, Y-axis direction). The vertical resolution therefore decreases to one-half the resolution of a typical 2D image.

On the other hand, when the polarization module 100 according to the present embodiment is used, the areas for displaying an image for the right eye and the areas for displaying an image for the left eye are alternately arranged in both the horizontal direction (row direction, X-axis direction) and the vertical direction (column direction, Y-axis direction).

For example, the areas T1 and T3 shown in FIG. 2 work as follows: an image for the right eye is displayed by the areas T3 in the odd-numbered rows and by the areas T1 in the even-numbered rows. Similarly, an image for the left eye is displayed by the areas T2 in the odd-numbered rows and by the areas T4 in the even-numbered rows.

That is, both the images for the right and left eyes are displayed in all the rows. The discrepancy in image resolution in the line-by-line method, that is, the vertical resolution is one-half the horizontal resolution, can therefore be solved, and the vertical resolution can be balanced with the horizontal resolution. Further, image portions in oblique directions can be smoothly expressed.

To alternately display an image for the right eye and an image for the left eye along two directions perpendicular to each other, the following method can also be used: Two types of quarter-wave plates having slow axes perpendicular to each other are alternately arranged in two directions perpendicular to each other.

For example, FIGS. 4A to 4C show a polarization module 110 configured by using the alternative method described above as Comparative Example. FIG. 4A shows the polarization module 110 viewed in the direction perpendicular to one principal surface thereof (Z-axis direction). FIG. 4B shows the polarization module 110 viewed in the Y-axis direction. FIG. 4C shows the polarization module 110 viewed in the X-axis direction.

The polarization module 110 according to Comparative Example includes a polarizer plate 1a, a plurality of first wave plates 2a and a plurality of second wave plates 3a disposed on one principal surface of the polarizer plate 1a, and a transparent resin plate 6a disposed on the plurality of first wave plates 2a and the plurality of second wave plates 3a.

Each of the first wave plates 2a and the second wave plates 3a has, for example, a nearly square principal surface. Each of the first wave plates 2a and the second wave plates 3a is a quarter-wave plate, and the slow axes of the first wave plates 2a are inclined to the polarization axis of the polarizer plate 1a by 45° in a predetermined direction. The slow axes of the second wave plates 3a are inclined to the polarization axis of the polarizer plate 1a by 45° but face away from the slow axes of the first wave plates 2a.

Further, the first wave plates 2a and the second wave plates 3a are alternately arranged in the X-axis and Y-axis directions.

The thus disposed first wave plates 2a and second wave plates 3a allow light having passed through the polarizer plate 1a and the first wave plates 2a and light having passed through the polarizer plate 1a and the second wave plates 3a to be light fluxes circularly polarized in opposite directions. The polarization module 110 can therefore display stereoscopic images, for example, by using the light having passed through the polarizer plate 1a and the first wave plates 2a to form an image for the right eye and the light having passed through the polarizer plate 1a and the second wave plates 3a to form an image for the left eye.

In Comparative Example, however, it is necessary to shape the first wave plates 2a and the second wave plates 3a into small pieces, for example, in correspondence with the areas for displaying an image for the right eye and the areas for displaying an image for the left eye, respectively, as shown in FIG. 4A.

When the first wave plates 2a and the second wave plates 3a are shaped into small pieces as described above, it is difficult to handle the wave plates when they are attached, for example, onto the polarizer plate 1a, and the attachment step tends to be complicated. Further, in general, a quarter-wave plate, when it is shipped from a distributer, may have protective films attached to the surfaces thereof. In this case, the protective films are removed and then the quarter-wave plate is mounted. However, when the quarter-wave plate is small, it is difficult to remove the protective films, resulting in cost increase.

Further, a small quarter-wave plate is also problematic in that the direction of the slow axis thereof is difficult to recognize.

In contrast, the polarization module 100 according to the present embodiment is so configured that a single first wave plate 2 and a single second wave plate 3 cover a plurality of image display areas R1 and L1 (see FIGS. 1A to 1C and 3). That is, the first wave plates 2 and the second wave plates 3, which are larger than those in Comparative Example, are readily handled.

In particular, in a large-screen display apparatus using, for example, LEDs as light sources, a pixel corresponding to a single dot has a size of several millimeters. In this case, using the polarization module 100 according to the present embodiment is particularly effective because the first wave plates 2 and the second wave plates 3, which are very large, can be readily handled.

Further, in the present embodiment, since the principal surface of each of the first wave plates 2 and the second wave plates 3 has a rectangular shape having longer sides and shorter sides, the orientation of each of the first wave plates 2 and the second wave plates 3 can be distinguished by external appearance, whereby the direction of the slow axis of each of the wave plates can be readily recognized.

### 2. Second Embodiment

### A Case Where Half-Wave Plates are Bonded to a Resin Plate

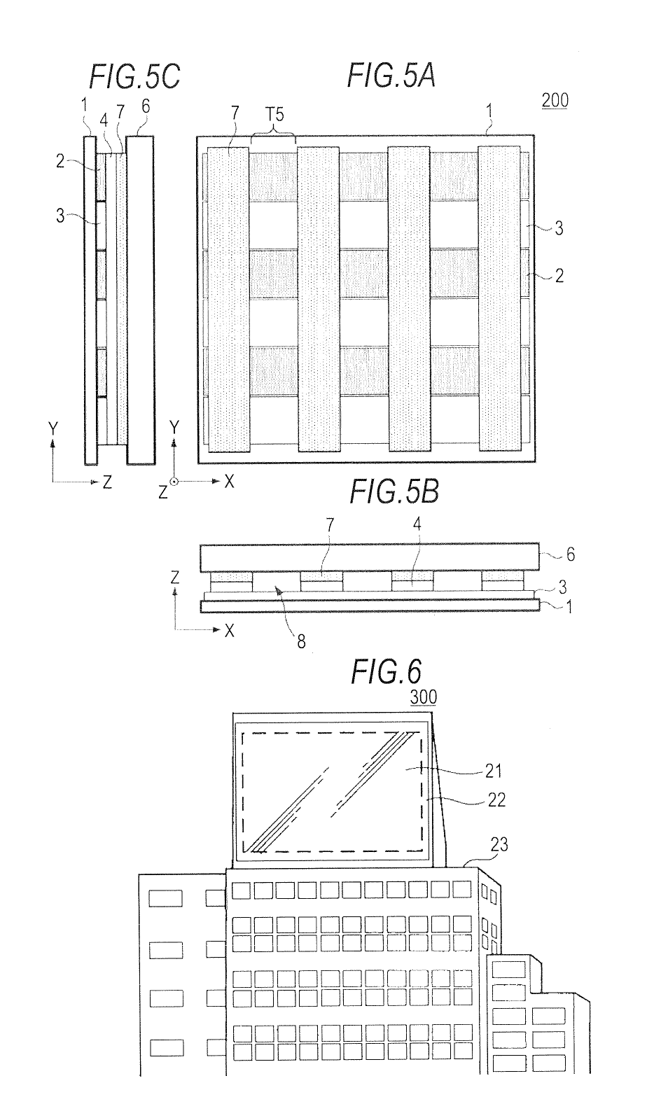

FIGS. 5A to 5C are schematic configuration diagrams showing the configuration of a polarization module 200 according to a second embodiment. FIG. 5A shows the polarization module 200 viewed in the direction perpendicular to one principal surface thereof (Z-axis direction). FIG. 5B shows the polarization module 200 viewed in the Y-axis direction. FIG. 5C shows the polarization module 200 viewed in the X-axis direction.

The portions corresponding to those in the first embodiment (see FIGS. 1A to 1C) have the same reference characters, and no redundant description will be made.

The polarization module 200 according to the present embodiment includes a polarizer plate 1, a plurality of first wave plates 2 and second wave plates 3 disposed on one principal surface of the polarizer plate 1, and a plurality of third wave plates 4 disposed on the plurality of first wave plates 2 and second wave plates 3.

The polarization module 200 according to the present embodiment further includes a plurality of transparent double-sided adhesive tapes 7 disposed on the plurality of third wave plates 4 and a transparent resin plate 6 disposed on the double-sided adhesive tapes

The resin plate 6 is not shown in FIG. 5A for ease of illustration.

The plurality of first wave plates 2 and the plurality of second wave plates 3 are disposed on one principal surface of the polarizer plate 1. Each of the first wave plates 2 and the second wave plates 3 is fixed to the polarizer plate 1, for example, with an optical adhesive, a UV curable resin, a photoelastic resin, or an optical adhesive tape.

The first wave plates 2 and the second wave plates 3 are alternately arranged along the shorter sides thereof (in Y-axis direction in FIG. 5A). In this process, the slow axes of the first wave plates 2 and the slow axes of the second wave plates 3 are inclined to the polarization axis of the polarizer plate 1 by 45° but face away from each other, as in the first embodiment.

The plurality of third wave plates 4 are arranged along the shorter sides thereof (in X-axis direction in FIG. 5A) at predetermined intervals. It is, however, noted that the plurality of third wave plates 4 are so arranged that the direction of the shorter sides thereof intersects the direction in which the first wave plates 2 and the second wave plates 3 are arranged (direction of shorter sides thereof).

In this process, the direction of the slow axes of the third wave plates 4 agrees with the direction of the slows axes of the first wave plates 2 or the direction of the slows axes of the second wave plates 3, as in the first embodiment.

The present embodiment differs from the first embodiment in that the transparent double-sided adhesive tapes 7 are disposed on the third wave plates 4 and that the double-sided adhesive tapes 7 fix the transparent resin plate 6 to the third wave plates 4.

In this case, the double-sided adhesive tapes 7 interposed between the third wave plates 4 and the resin plate 6 prevents any air layer from being created between the third wave plates 4 and the resin plate 6.

Above the portions of the first wave plates 2 and the second wave plates 3 where no third wave plates 4 are disposed, however, air layers 8 (see FIG. 5B) are present between the first wave plates 2/the second wave plates 3 and the resin plate 6 as indicated, for example, by areas T5 shown in FIG. 5A.

When the air layers 8 are present, light tends to be reflected off the interface between the first wave plates 2/the second wave plates 3 and the air layers 8 or the interface between the resin plate 6 and the air layers. It is therefore preferable in the present embodiment to form antireflection films on the areas T5 of the first wave plates 2 and the second wave plates 3 where no third wave plates 4 are disposed.

The antireflection films can be formed by performing sputtering on the first wave plates 2 and the second wave plates 3, for example, through a mask or any other suitable component having openings corresponding to the areas T5 described above.

Similarly, an antireflection film can be formed on the surface of the resin plate 6 that faces the first wave plates 2 and the second wave plates 3.

As described above, in the present embodiment, the third wave plates 4 (half-wave plates) are also arranged on the first wave plates 2 and the second wave plates 3 (quarter-wave plates), which are alternately arranged, in such a way that the direction in which the third wave plates 4 are arranged intersects the direction in which the first wave plates 2 and the second wave plates 3 are arranged.

As a result, two areas through which light fluxes circularly polarized in opposite directions exit are alternately arranged in two direction perpendicular to each other (X-axis and Y-axis directions), as in the first embodiment, whereby the resolution in the vertical direction (Y-axis direction) will not decrease.

The advantageous effects provided by the other configurations are the same as those provided in the first embodiment.

### 3. Third Embodiment

### Example of Image Display Apparatus

FIG. 6 is a perspective view showing an image display apparatus 300 according to a third embodiment. The image display apparatus 300 according to the present embodiment includes an image display unit 21 and a polarization module 22 disposed thereon.

The image display apparatus 300 is a large-screen image display apparatus using, for example, LEDs as light emitting devices and installed on the rooftop, a wall, or any other surface of a building. In FIG. 6, the image display apparatus 300 is installed on the rooftop of a building 23 by way of example.

The image display apparatus 300 according to the present embodiment can also be used in indoor applications, for example, can be installed in an event hall or a showroom.

The image display unit 21 is formed, for example, of the display panel 10 (see FIG. 3) shown in the first embodiment. For example, in the image display unit 21, a single pixel area is formed at each of the intersections of a plurality of scan lines and a plurality of signal lines disposed in the direction perpendicular to the scan lines. Further, for each pixel, a semiconductor device or any other device that drives the pixel is disposed.

For example, the scan lines are connected to a scan line drive circuit (not shown), and the semiconductor devices are turned on with pulse voltages from the scan line drive circuit.

When any of the semiconductor devices is turned on, a video signal according to luminance information is supplied from a signal drive circuit to the light emitting device, which then emits light having luminance according to a current value of the video signal to form an image.

Further, the signal drive circuit supplies the light emitting devices in the pixel areas of the display panel 10 that display an image for the right eye with a video signal corresponding to the image for the right eye and supplies the light emitting devices in the pixel areas of the display panel 10 that display an image for the left eye with a video signal corresponding to the image for the left eye.

The polarization module 22 is, for example, either of the polarization modules 100 and 200 shown in the first and second embodiment (see FIGS. 1A to 1C and 5A to 5C).

In the polarization modules 100 and 200, the third wave plates 4 are so arranged on the first wave plates 2 and the second wave plates 3 that the direction in which the third wave plates 4 are arranged intersects (at right angles) the direction in which the first wave plates 2 and the second wave plates 3 are arranged, as described above. As a result, since an area for displaying an image for the right eye and an area for displaying an image for the left eye can be alternately arranged in the image display unit 21 in two directions perpendicular to each other, the vertical resolution can be balanced with the horizontal direction, whereby high-quality stereoscopic images can be provided.

The embodiments of the polarization module and the image display apparatus have been described above. The present technology is not limited to the embodiments described above but encompasses a variety of conceivable modes to the extent that they do not depart from the substance of the present technology set forth in the appended claims.

The present technology can also be implemented as the following configurations.

(1) A polarization module including
a polarizer plate,
a plurality of first quarter-wave plates so disposed on the polarizer plate that slow axes of the first quarter-wave plates are inclined to a polarization axis of the polarizer plate by 45 degrees,
a plurality of second quarter-wave plates so disposed on the polarizer plate in alternation with the first quarter-wave plates that slow axes of the second quarter-wave plates are inclined to the polarization axis of the polarizer plate by 45 degrees but face away from the slow axes of the first quarter-wave plates, and
a plurality of half-wave plates so disposed at predetermined intervals on the plurality of first quarter-wave plates and the plurality of second quarter-wave plates that the direction in which the plurality of half-wave plates are arranged intersects the direction in which the plurality of first quarter-wave plates and the plurality of second quarter-wave plates are arranged.

(2) The polarization module described in (1),
further including a transparent, optically isotropic resin plate disposed on the plurality of half-wave plates.

(3) The polarization module described in (2),
wherein the resin plate is fixed to the plurality of first quarter-wave plates and the plurality of second quarter-wave plates with transparent double-sided adhesive tapes disposed on the plurality of first quarter-wave plates and the plurality of second quarter-wave plates and between the plurality of half-wave plates.

(4) The polarization module described in (3),
wherein an antireflection film is provided on a principal surface of each of the half-wave plates that faces the resin plate.

(5) The polarization module described in any of (2) to (4),
wherein the resin plate is fixed to the plurality of half-wave plates with transparent double-sided adhesive tapes.

(6) The polarization module described in (5),
wherein antireflection films are provided on portions of the plurality of first quarter-wave plates and the plurality of second quarter-wave plates where the half-wave plates are not disposed.

(7) An image display apparatus including
a display panel having a first pixel area for displaying an image for the right eye and a second pixel area for displaying an image for the left eye alternately arranged in two intersecting directions, and
a polarization module disposed on the display panel and including a polarizer plate, a plurality of first quarter-wave plates so disposed on the polarizer plate that slow axes of the first quarter-wave plates are inclined to a polarization axis of the polarizer plate by 45 degrees, a plurality of second quarter-wave plates so disposed on the polarizer plate in alternation with the first quarter-wave plates that slow axes of the second quarter-wave plates are inclined to the polarization axis of the polarizer plate by 45 degrees but face away from the slow axes of the first quarter-wave plates, and a plurality of half-wave plates so disposed at predetermined intervals on the plurality of first quarter-wave plates and the plurality of second quarter-wave plates that the direction in which the plurality of half-wave plates are arranged intersects the direction in which the plurality of first quarter-wave plates and the plurality of second quarter-wave plates are arranged,
wherein the display panel is attached on a surface of the polarizer plate of the polarization module that faces away from the half-wave plates.

(8) The image display apparatus described in (7),
wherein each of the pixels is formed of an LED, an organic EL device, or any other self-luminous device.

(9) The image display apparatus described in (8),
wherein the first pixel areas of the display panel are so disposed that the first pixel areas face not only areas where the second quarter-wave plates and the half-wave plates of the polarization module overlap with each other but also areas where the half-wave plates are not disposed on the first quarter-wave plates, and
the second pixel areas of the display panel are so disposed that the second pixel areas face not only areas where the first quarter-wave plates and the half-wave plates of the polarization module overlap with each other but also areas where the half-wave plates are not disposed on the second quarter-wave plates.

The present disclosure contains subject matter related to that disclosed in Japanese Priority Patent Applications JP 2011-134913 and JP 2011-136346 filed in the Japan Patent Office on Jun. 17, 2011 and Jun. 20, 2011, respectively, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A polarization module comprising:
a polarizer plate;
a plurality of first quarter-wave plates so disposed at predetermined intervals on the polarizer plate that slow axes of the first quarter-wave plates are inclined to a polarization axis of the polarizer plate by 45 degrees;
a plurality of second quarter-wave plates so disposed on the polarizer plate in alternation with the first quarter-wave plates that slow axes of the second quarter-wave plates are inclined to the polarization axis of the polarizer plate by 45 degrees but face away from the slow axes of the first quarter-wave plates; and
a plurality of half-wave plates so disposed at predetermined intervals on the plurality of first quarter-wave plates and the plurality of second quarter-wave plates that the direction in which the plurality of half-wave plates are arranged intersects the direction in which the plurality of first quarter-wave plates and the plurality of second quarter-wave plates are arranged.

2. The polarization module according to claim 1,
further comprising a transparent, optically isotropic resin plate disposed on the plurality of half-wave plates.

3. The polarization module according to claim 2,
further comprising a plurality of transparent double-sided adhesive tapes disposed on the plurality of first quarter-wave plates and the plurality of second quarter-wave plates and between the plurality of half-wave plates and fixing the plurality of first quarter-wave plates and the plurality of second quarter-wave plates to the resin plate.

4. The polarization module according to claim 3,
further comprising an antireflection film provided on a principal surface of each of the half-wave plates that faces the resin plate.

5. The polarization module according to claim 2,
wherein the resin plate is fixed to the plurality of half-wave plates with transparent double-sided adhesive tapes.

6. The polarization module according to claim 5,
further comprising antireflection films provided on portions of the plurality of first quarter-wave plates and the plurality of second quarter-wave plates where the half-wave plates are not disposed.

7. An image display apparatus comprising:
a display panel having a first pixel area for displaying an image for the right eye and a second pixel area for displaying an image for the left eye alternately arranged in two intersecting directions; and
a polarization module disposed on the display panel and including a polarizer plate, a plurality of first quarter-wave plates so disposed on the polarizer plate at predetermined intervals that slow axes of the first quarter-wave plates are inclined to a polarization axis of the polarizer plate by 45 degrees, a plurality of second quarter-wave plates so disposed on the polarizer plate in alternation with the first quarter-wave plates that slow axes of the second quarter-wave plates are inclined to the polarization axis of the polarizer plate by 45 degrees but face away from the slow axes of the first quarter-wave plates, and a plurality of half-wave plates so disposed at predetermined intervals on the plurality of first quarter-wave plates and the plurality of second quarter-wave plates that the direction in which the plurality of half-wave plates are arranged intersects the direction in which the plurality of first quarter-wave plates and the plurality of second quarter-wave plates are arranged,
wherein the display panel is attached on a surface of the polarizer plate of the polarization module that faces away from the half-wave plates.

8. The image display apparatus according to claim 7,
wherein each of the pixels is formed of an LED, an organic EL device, or any other self-luminous device.

9. The image display apparatus according to claim 8,
wherein the first pixel areas of the display panel are so disposed that the first pixel areas face not only areas where the second quarter-wave plates and the half-wave plates of the polarization module overlap with each other but also areas where the half-wave plates are not disposed on the first quarter-wave plates, and
the second pixel areas of the display panel are so disposed that the second pixel areas face not only areas where the first quarter-wave plates and the half-wave plates of the polarization module overlap with each other but also areas where the half-wave plates are not disposed on the second quarter-wave plates.
